(19) United States
(12) Patent Application Publication
(10) Pub. No.: US 2009/0272086 A1
(43) Pub. Date: Nov. 5, 2009

(54) NANOFIBER FILTER MEDIUM AND METHOD FOR MANUFACTURING THE SAME

(75) Inventors: Hung-Yi Hsiao, Hsinchu City (TW); Chiung-Ying Chan, Wufong Township (TW); Chia-Chun Lin, Hsinchue County (TW); Shu-Hui Cheng, Hsinchu County (TW)

Correspondence Address: LOWE HAUPTMAN HAM & BERNER, LLP, 1700 DIAGONAL ROAD, SUITE 300, ALEXANDRIA, VA, 22314, US

(73) Assignee: INDUSTRIAL TECHNOLOGY RESEARCH INSTITUTE, Hsinchu (TW)

(21) Appl. No.: 12/258,812

(22) Filed: Oct. 27, 2008

(30) Foreign Application Priority Data
May 5, 2008 (TW) 097116467

(51) Int. Cl. B01D 39/14; B01D 39/16; D01D 5/00

(52) U.S. Cl. 55/528; 55/527; 264/484

(57) ABSTRACT

Disclosed is a nanofiber filter medium formed by electrospinning, having a low pressure drop and high filtration performance. The nanofiber layer thereof is constructed by at least two nanofibers, uniformly entangled with each other, with different fiber diameter distributions. Therefore, the nanofiber filter medium of the invention is completed. The described nanofiber filter medium has a low pressure drop and high filtration performance.

### CROSS REFERENCE TO RELATED APPLICATIONS

This Application claims priority of Taiwan Patent Application No. 097116467, filed on May 5, 2008, the entirety of which is incorporated by reference herein.

### BACKGROUND OF THE INVENTION

1. Field of the Invention

The invention relates to a nanofiber filter medium for filtering air particles, and in particular to the structure and the manufacturing thereof.

2. Description of the Related Art

High efficiency particulate air (hereinafter HEPA) filters are filter mediums that have filtration performances of greater than 99.97% and filter pressure drop of less than 32 mm H₂O for 260 nm particles at a face velocity of 5.3 cm/sec. Meanwhile, filter mediums that have filtration performances of greater than 94% and filter pressure drop of less than 94 mm H₂O for 260 nm particles at a face velocity of 14 cm/sec, are also considered HEPA filters. HEPA filter mediums can be used as air filters for semiconductor manufacturing or a biological clean room. Having stable performing HEPA filter mediums are critical to preventing air particles from damaging semiconductor products or clean room substances.

Currently, the main type of commercially available HEPA filter mediums utilized are made of glass non-woven fabric or polypropylene melt-blown non-woven fabric. The glass fiber non-woven fabric becomes brittle when folded. Meanwhile, because the polypropylene melt-blown non-woven fabric is soft due to its low mechanism strength, the material requires folding with other matrix substances after a static treatment. As such, the described conventional filter mediums have application limitations. Conventional filter mediums must have high weight per unit area (exceeding 70 g/m²) and high filter pressure drop, if requirement for the filtration performance thereof is greater than 99.97% and filter pressure drop is less than 32 mm H₂O for 260 nm particles at a face velocity of 5.3 cm/sec.

Accordingly, a novel filter medium material and structure is called for to overcome the previously described problems.

### SUMMARY OF THE INVENTION

The invention provides a nanofiber filter medium, comprising a substrate and a nanofiber layer. The nanofiber layer comprises a first nanofiber having a first fiber diameter distribution and a second nanofiber having a second fiber diameter distribution, wherein the first and second nanofibers have the same or different composition, and the first fiber diameter distribution is different from the second fiber diameter distribution.

The invention also provides a method for forming a nanofiber filter medium, comprising providing a substrate, and spitting at least two polymer solutions by electrospinning to form at least two nanofibers having at least two fiber diameter distributions, wherein the nanofibers are uniformly entangled with each other to form a nanofiber layer on the substrate.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is an illustration of the electrospinning apparatus for forming the nanofiber filter medium of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a nanofiber filter medium formed by electrospinning a polymer solution. The filter medium includes a substrate and a nanofiber layer. The nanofibers of the nanofiber layer have several fiber diameter distributions. The invention also provides a method for forming the nanofiber filter medium, in which a substrate is provided, and at least two polymer solutions are spitted by electrospinning to form at least two nanofibers having at least two fiber diameter distributions. The nanofibers are uniformly entangled with each other to form a nanofiber layer on the substrate.

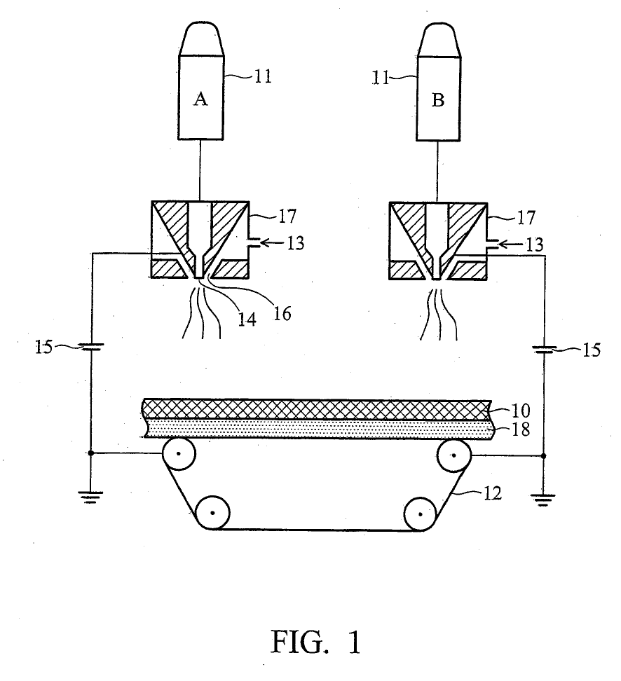

FIG. 1 shows an electrospinning apparatus for forming a nanofiber filter medium from polymer solutions, within an electric field. First, an applicable polymer is dissolved in an appropriate solvent to prepare a polymer solution of different concentrations. The preferred polymer solution includes electret materials such as polypropylene (PP), polycarbonate (PC), cyclo-olefin copolymer (COC), or metallocene catalyzed cyclo-olefin copolymer (mCOC). The concentration of the polymer solution is 3% to 30%. If the concentration is less than 3%, it will tend to form droplets other than the nanofibers. If the concentration is higher than 30%, the formed nanofibers are too thick, such that the filtration performance thereof does not reach invention requirements. The polymer solution is then set into a container 11. For simplicity, FIG. 1 only shows two polymer solutions A and B for forming two nanofibers with two fiber diameter distributions. It is understood that the types and the concentration of the polymer solutions are not limited to two types, and can be changed to 3, 4, or more than a dozen types, if necessary.

Subsequently, the described polymer solutions are spitted from a spinneret 17 connected to a high-voltage source 15 to form nanofibers, within an electric field by static electricity. The high voltage source 15 is 10 kV to 45 kV. The spinneret 17 has an air nozzle 16 to aid and accelerate the polymer solution to be spit by the spinning nozzle 14. The solvent of the spitted polymer solution is evaporated, such that the polymer is separated into several strands of nanofibers on the substrate. The collection belt 12 spun at a higher speed, will form a thinner nanofiber layer 10. On the other hand, a thicker nanofiber layer 10 can be obtained by slowing down the spinning speed of the collection belt 12. Thus, completing the nanofiber filter medium of the invention. Optionally, a corona treatment can be applied to the nanofiber layer 10 to make it electret, such that its collection efficiency of powder particles can be enhanced. While the nanofiber is an electret material, its static electricity can be retained for over 1 month if located in a dry environment. For air particles, a electrostatic nanofiber layer has better absorption ability.

Note that the nanofiber material of the invention is not limited to a specific polymer, different polymer solutions A and B with different concentrations or variety form nanofibers having different fiber diameter distributions, respectively. A higher polymer solution concentration results in thicker nanofibers, and a lower concentration thereof causes thinner nanofibers. While thicker nanofibers have lower filter pressure drop when air passes through, they cannot efficiently collect air particles. On the other hand, thinner nanofibers can efficiently collect air particles but have higher filter pressure drop. The nanofiber layer of the invention is composed of at least two nanofibers of different fiber diameter distributions, such that its filtration performance is improved without sacrificing pressure drop. In one embodiment, the nanofibers have a fiber diameter distribution of 30 nm to 300 nm. In one embodiment, a first type of nanofiber has a fiber diameter distribution of 50 nm to 100 nm, and a second type of the nanofiber has a fiber diameter distribution of 140 nm to 300 nm, respectively. In another embodiment, the described nanofiber layer further includes a third type of nanofiber having a fiber diameter distribution of 85 nm to 140 nm. The nanofibers of different fiber diameter distributions form a nanofiber layer matrix having a thickness of less than 20 μm, preferably 10 μm to 20 μm. The nanofiber filter medium has filter pressure drop of less than 5 mm H₂O and filtration performance greater than 99% for 260 nm particles at a face velocity of 5.3 cm/sec. The nanofiber layer has a basis weight of less than 10 g/m², preferably less than 5 g/m².

The filtration performance was measured by an instrument (TSI 8130) and pressure drop thereof was 260 nm particles at a face velocity of 5.3 cm/sec or 14 cm/sec. The filtered property can be represented as QF (quality factor) in the Equation 1. For select testing factors such as face velocity or particle size, a higher QF value means better filtration performance.

$$QF = - ln \frac{particle peneration ratio}{pressure drop} \qquad ( Equation 1 )$$

Finally, the substrate 18 of the nanofiber filter medium of the invention can be cotton web, foam, paper, sheet, or non-woven fabric. The substrate 18 and the nanofiber layer 10 is required to have enough adhesion and support therebetween to prevent lamination during manufacturing, transportation, or application.

### EXAMPLES AND COMPARATIVE EXAMPLES

### Example 1

Polycarbonate was dissolved in a tetrahedronfuran (THF) and dimethylethylamine co-solvent to form 12% and 15% polymer solutions, respectively. The 12% and 15% polymer solutions were electrospinned within an electric field to form two types of nanofibers having two fiber diameter distributions. The nanofibers were uniformly entangled to form a nanofiber layer on a melt-blown non-woven cotton web substrate. The described cotton web substrate had a basis weight of 15 g/m². Referring to FIG. 1, the spinneret and the substrate had a distance therebetween of 20 cm. The spinneret had an air nozzle to aid and accelerate the polymer solution to be spit by the spinning nozzle. The high voltage source was 40 kV, and the consumption ratio of the polymer solutions was 25 μL/minute·spinning nozzle. The nanofiber layer had a basis weight of 1.22 g/m² and thickness of 10 μm. The nanofibers had an average fiber diameter of 118±20 nm. The filtered properties of the nanofiber filter layer were measured by an instrument (TSI 8130) and pressure drop thereof was 260 nm particles at a face velocity of 14 cm/sec. The measurement is tabulated, and are shown Table 1. A corona treatment was performed on the nanofiber layer, and its filtered properties were measured and tabulated, and are shown in Table 2.

### Example 2

The polymer type, co-solvent, electrospinning method, and substrate for Example 2, were similar to Example 1. In Example 2, the polymer solutions had three concentrations: 12%, 13.5%, and 15%. The polymer solutions were electrospinned within an electric field to form three types of nanofibers having three fiber diameter distributions. The nanofibers were uniformly entangled to form a nanofiber layer on a melt-blown non-woven cotton web substrate. The nanofiber layer had a basis weight of 1.36 g/m² and thickness of 11 μm. The nanofibers had an average fiber diameter of 150±30 nm. The filtered properties of the nanofiber filter layer were measured by an instrument (TSI 8130) and pressure drop thereof was 260 nm particles at a face velocity of 14 cm/sec. The measurement was tabulated, and are shown Table 1. A corona treatment was performed on the nanofiber layer, and its filtered properties were measured and tabulated, and are shown in Table 2.

### Example 3

The polymer type, the polymer solution concentration, co-solvent, electrospinning method, and substrate for Example 3, were similar to Example 2. In Example 3, the nanofiber filter medium in Example 2 was stacked to form a bi-layer nanofiber filter medium. The filtered properties of the bi-layer nanofiber filter medium were measured by an instrument (TSI 8130) and pressure drop thereof was 260 nm particles at a face velocity of 5.3 cm/sec. The measurement was tabulated, and are shown in Table 3.

### Comparative Example 1

Polycarbonate was dissolved in a THF and dimethylethylamine co-solvent to form a 12% polymer solution. The 12% polymer solution was electrospinned within an electric field to form nanofibers having single fiber diameter distribution. The nanofibers were uniformly entangled to form a nanofiber layer on a melt-blown non-woven cotton web substrate. The described cotton web substrate had a basis weight of 15 g/m². Referring to FIG. 1, the spinneret and the substrate had a distance therebetween of 20 cm. The spinneret had an air nozzle to aid and accelerate the polymer solution to be spit by the spinning nozzle. The high voltage source was 40 kV, and the consumption ratio of the polymer solutions was 25 μL/minute·spinning nozzle. The nanofiber layer had a basis weight of 1.12 g/m² and thickness of 9 μm. The nanofibers had an average fiber diameter of 84±15 nm. The filtered properties of the nanofiber filter layer were measured by an instrument (TSI 8130) and pressure drop thereof was 260 nm particles at a face velocity of 14 cm/sec. The measurement was tabulated, and are shown in Table 1. A corona treatment was performed on the nanofiber layer, and its filtered properties were measured and tabulated, and are shown in Table 2.

### Comparative Example 2

The polymer type, co-solvent, electrospinning method, and substrate for Comparative Example 2, were similar to Comparative Example 1. In Comparative Example 2, the concentration of the polymer solution was 13.5%. The polymer solution was electrospinned within an electric field to form nanofibers having single fiber diameter distributions. The nanofibers were uniformly entangled to form a nanofiber layer on a melt-blown non-woven cotton web substrate. The nanofiber layer had a basis weight of 1.28 g/m² and thickness of 10 μm. The nanofibers had an average fiber diameter of 102±15 nm. The filtered properties of the nanofiber filter layer were measured by an instrument (TSI 8130) and pressure drop thereof was 260 nm particles at a face velocity of 14 cm/sec. The measurement was tabulated in Table 1. A corona treatment was performed on the nanofiber layer, and its filtered properties were measured and tabulated, and are shown in Table 2.

### Comparative Example 3

The polymer type, co-solvent, electrospinning method, and substrate for Comparative Example 3, were similar to Comparative Example 1. In Comparative Example 3, the concentration of the polymer solution was 15%. The polymer solution was electrospinned within an electric field to form nanofibers having single fiber diameter distributions. The nanofibers were uniformly entangled to form a nanofiber layer on a melt-blown non-woven cotton web substrate. The nanofiber layer had a basis weight of 1.56 g/m² and thickness of 12 μm. The nanofibers had an average fiber diameter of 165±15 nm. The filtered properties of the nanofiber filter layer were measured by an instrument (TSI 8130) and pressure drop thereof was 260 nm particles at a face velocity of 14 cm/sec. The measurement is tabulated in Table 1. A corona treatment was performed on the nanofiber layer, and its filtered properties were measured and tabulated, and are shown in Table 2.

TABLE 1

| | Filtered properties | | |
|---|---|---|---|
| | No corona treatment | | |
| Examples and | Filtration | Pressure drop | |
| Comparative Examples | performance(%) | (mm H₂O) | QF |
| Example 1 | 80.6 | 8.7 | 0.188 |
| Example 2 | 91.7 | 11.97 | 0.208 |
| Comparative Example 1 | 74.63 | 8.07 | 0.170 |
| Comparative Example 2 | 84.23 | 12.23 | 0.151 |
| Comparative Example 3 | 86.5 | 10.97 | 0.183 |

TABLE 2

| | Filtered properties | | |
|---|---|---|---|
| | After corona treatment | | |
| Examples and | Filtration | Pressure drop | |
| Comparative Examples | performance(%) | (mm H₂O) | QF |
| Example 1 | 87.23 | 11.77 | 0.175 |
| Example 2 | 97.43 | 12.67 | 0.289 |
| Comparative Example 1 | 84.2 | 7.6 | 0.243 |
| Comparative Example 2 | 91.42 | 14.57 | 0.169 |
| Comparative Example 3 | 91.07 | 11.83 | 0.204 |

TABLE 3

| | Filtered properties | | | | |
|---|---|---|---|---|---|
| | Substrate | Nanofiber | After Corona treatment | | |
| | basis | layer basis | Filtration | Pressure | |
| | weight | weight | performance | drop | |
| Examples | (g/m²) | (g/m²) | (%) | (mm H₂O) | QF |
| single-layer | 15 | 1.36 | 99.12 | 4.3 | 1.10 |
| nanofiber | | | | | |
| filter medium | | | | | |
| bi-layer | 30 | 2.72 | 99.97 | 10.63 | 0.76 |
| nanofiber | | | | | |
| filter medium | | | | | |

As shown in Table's 1 and 2, the nanofiber layers composed of at least two types of nanofibers having different diameter distributions had both low pressure drop and high filtration performance. As shown in Table 3, the bi-layer nanofiber filter medium measured by the instrument (TSI 8130), had pressure drop of 260 nm particles at a face velocity of 5.3 cm/sec, and showed improved filtered properties such as a lighter weight, lower pressure drop, and higher filtration performance than a conventional HEPA glass fiber filtrate.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A nanofiber filter medium, comprising:
a substrate; and
a nanofiber layer, comprising:
a first nanofiber having a first fiber diameter distribution; and
a second nanofiber having a second fiber diameter distribution,
wherein the first and second nanofibers have same or different compositions, and the first fiber diameter distribution is different from the second fiber diameter distribution.

2. The nanofiber filter medium as claimed in claim 1, wherein the first fiber diameter distribution is between 50 nm to 100 nm, and the second fiber diameter distribution is between 140 nm to 300 nm.

3. The nanofiber filter medium as claimed in claim 1, wherein the first and second nanofibers comprise polypropylene, polycarbonate, cyclo-olefin copolymer, or metallocene catalyzed cyclo-olefin copolymer.

4. The nanofiber filter medium as claimed in claim 1, wherein the nanofiber layer has a thickness less than 20 μm.

5. The nanofiber filter medium as claimed in claim 1, wherein the nanofiber layer has a basis weight of less than 10 g/m².

6. The nanofiber filter medium as claimed in claim 1 has filtration performance greater than 99% for 260 nm particles at a face velocity of 5.3 cm/sec.

7. The nanofiber filter medium as claimed in claim 1, having a filter pressure drop of less than 5 mm H₂O for 260 nm particles at a face velocity of 5.3 cm/sec.

8. The nanofiber filter medium as claimed in claim 1, wherein the substrate comprises cotton web, foam, paper, sheet, or non-woven fabric.

9. The nanofiber filter medium as claimed in claim 1, wherein the nanofiber layer further comprises a third nanofiber having a third fiber diameter distribution between 85 nm to 140 nm.

10. A method for forming a nanofiber filter medium, comprising:
providing a substrate; and
spitting at least two polymer solutions by electrospinning to form at least two nanofibers having at least two fiber diameter distributions,
wherein the nanofibers are uniformly entangled with each other to form a nanofiber layer on the substrate.

11. The method as claimed in claim 10, wherein the substrate comprises cotton web, foam, paper, sheet, or non-woven fabric.

12. The method as claimed in claim 10, wherein the solvent of the polymer solution comprises chloroform, tetrahedrofuran, dimethylethylamine, or co-solvents thereof.

13. The method as claimed in claim 10, wherein the solute of the polymer solution comprises polypropylene, polycarbonate, cyclo-olefin copolymer, or metallocene catalyzed cyclo-olefin copolymer.

14. The method as claimed in claim 10, wherein the polymer solution has a concentration of 3% to 30%.

15. The method as claimed in claim 10, wherein the nanofibers have fiber diameter distributions of 30 nm to 300 nm.

16. The method as claimed in claim 10, further comprising a corona treatment for the nanofiber filter medium to have a static electricity property.
